(19) United States
(12) Patent Application Publication
(10) Pub. No.: US 2025/0178517 A1
(43) Pub. Date: Jun. 5, 2025

(54) DEVICE FOR DETECTING AN INCLINATION ANGLE

(71) Applicant: ZF Friedrichshafen AG, Friedrichshafen (DE)

(72) Inventors: Alexander Lundberg, Melle (DE); Marcel-Frederic Böhse, Preußisch Oldendorf (DE); Julian Stratmann, Bad Essen (DE)

(73) Assignee: ZF Friedrichshafen AG, Friedrichshafen (DE)

(21) Appl. No.: 18/969,946

(22) Filed: Dec. 5, 2024

(30) Foreign Application Priority Data
Dec. 5, 2023 (DE) 10 2023 212 211.1

(51) Int. Cl. B60Q 1/10

(52) U.S. Cl. CPC B60Q 1/10; B60Q 2300/132

(57) ABSTRACT

A device for detecting an angle of inclination of a vehicle having a chassis, a vehicle body carried by the chassis and connected by springs to unsprung components of the chassis. Vehicle wheels are coupled to the vehicle body by chassis control arms. Sensor arrangements, including at least one body sensor arrangement, are provided on the vehicle body and one or more chassis sensor arrangements is on the unsprung components of the chassis and/or the chassis control arms. Each sensor arrangement has acceleration sensors to detect translatory accelerations in different spatial directions and provide acceleration signals. An evaluation device connected to the sensor arrangements determines a pitch angle from the acceleration signals. Rotational movement sensors detect rotational movements about different axes and provide and body rotational movement signals characterizing these rotational movements. The pitch angle can be determined by the evaluation device using the body rotational movement signals.

### RELATED APPLICATIONS

This application claims the benefit of and right of priority under 35 U.S.C. § 119 to German Patent Application no. 10 2023 212 211.1, filed on 5 Dec. 2023, the contents of which are incorporated herein by reference in its entirety.

### FIELD OF THE DISCLOSURE

The invention relates to a device for detecting at least one angle of inclination of a vehicle, which has a chassis with several vehicle wheels that stand on or roll over a ground, a vehicle body supported by the chassis and connected by vehicle springs to unsprung components of the chassis that include the vehicle wheels, which are coupled to the vehicle body by means of chassis control arms, a plurality of sensor arrangements, of which at least one body sensor arrangement is provided on the vehicle body and one or more chassis sensor arrangement(s) is/are provided on the unsprung components of the chassis and/or the chassis control arms, wherein each sensor arrangement comprises a plurality of acceleration sensors, by means of which translatory accelerations in different spatial directions can be detected and acceleration signals characterizing these accelerations can be provided, and an evaluation device connected to the sensor arrangements, by means of which a pitch angle of the vehicle can be determined from the acceleration signals.

### BACKGROUND

DE 10 2018 210 586 B3 discloses a device for automatically adjusting the headlight range of a front headlight device of a vehicle having a plurality of vehicle wheels with pneumatic tires, comprising a control device which is designed to determine a pitch angle of the vehicle and to adjust a light emission of the front headlight device based on the determined pitch angle, a first acceleration sensor arranged on the vehicle in a substantially fixed orientation relative to the ground of the vehicle, and a second acceleration sensor arranged on the vehicle in a fixed orientation relative to the front headlight device of the vehicle, which are designed to measure in each case at least the direction of an acceleration present at the location of the respective acceleration sensor, wherein the control device is designed to determine the pitch angle based on the directions of the accelerations measured with the first and second acceleration sensors.

Due to the vehicle springs, the body can sway relative to the unsprung components of the chassis, so that determining the orientation of the vehicle body using translational acceleration sensors can be inaccurate. However, this means that the determined pitch angle may also be inaccurate.

### SUMMARY

On this basis, the invention is particularly aimed at increasing the accuracy with which the pitch angle can be determined.

This task is solved by a device and by a method according to the present disclosure. Preferred embodiments of the invention are set forth in the following description.

A device for detecting at least one angle of inclination of a vehicle, which has a chassis with a plurality of vehicle wheels that stand on or roll on a ground, a vehicle body that is supported by the chassis and is connected by vehicle springs to unsprung components of the chassis that include the vehicle wheels, which are coupled to the vehicle body by chassis control arms, a plurality of sensor arrangements, of which at least one body sensor arrangement is provided on the vehicle body and one or more chassis sensor arrangements on the unsprung components of the chassis and/or the chassis control arms, wherein each sensor arrangement comprises a plurality of acceleration sensors, by means of which translatory accelerations in different spatial directions can be detected and acceleration signals characterizing these accelerations can be provided, and an evaluation device connected to the sensor arrangements, by means of which acceleration signals, a pitch angle of the vehicle can be determined, is further developed according to the invention in particular by the fact that the body sensor arrangement comprises a plurality of rotational movement sensors, by means of which rotational movements about different axes of rotation can be detected and body rotational movement signals characterizing these rotational movements can be provided, wherein the pitch angle can also be determined by means of the evaluation device while taking into account the body rotational movement signals. In particular, the pitch angle of the vehicle can thus be determined from the acceleration signals and the body rotational movement signals using the evaluation device.

If the accelerometers of the body sensor arrangement are subjected to a rotational movement due to a vibrating vehicle body, the acceleration signals provided by these accelerometers may also have rotational signal components in addition to translational signal components, which can reduce the accuracy of the pitch angle determination. By detecting the rotational movements, it is possible to at least partially calculate and/or compensate for these rotary signal components and thus increase the accuracy of the pitch angle.

The invention relates in particular to a method for detecting at least one angle of inclination of a vehicle, which has a chassis with several vehicle wheels that stand on or roll on a ground, a vehicle body supported by the chassis, which is connected by vehicle springs to unsprung components of the chassis that include the vehicle wheels, which are linked to the vehicle body by chassis control arms, and several sensor arrangements, of which at least one body sensor arrangement is provided on the vehicle body and one or more chassis sensor arrangements are provided on the unsprung components of the chassis and/or the chassis control arms, wherein each sensor arrangement comprises a plurality of acceleration sensors by means of which translational accelerations in different spatial directions are detected and acceleration signals characterizing these accelerations are provided, from which signals a pitch angle of the vehicle is determined. The method is further developed in particular by the fact that the body sensor arrangement comprises a plurality of rotational movement sensors, by means of which rotational movements about different axes of rotation are detected and body rotational movement signals characterizing these rotational movements are provided, wherein the pitch angle can also be determined taking into account the body rotational movement signals. In particular, the pitch angle of the vehicle is determined from the acceleration signals and the body rotational movement signals.

Preferably, the vehicle according to the method has an evaluation device connected to the sensor arrangements, by means of which the pitch angle of the vehicle is determined from the acceleration signals. Preferably, the method of the pitch angle is additionally determined by the evaluation device, taking into account the body rotational movement signals. In particular, the pitch angle of the vehicle is determined from the acceleration signals and the body rotational movement signals by means of the evaluation device.

The method according to the invention is preferably carried out with the device according to the invention. In particular, the method according to the invention can be further developed in accordance with all the designs explained in connection with the device according to the invention. Furthermore, the device according to the invention can, for example, be further developed in accordance with all the designs explained in connection with the method according to the invention.

The pitch angle is, in particular, an angle of inclination of the vehicle. A pitch angle signal characterizing the pitch angle can be or is provided and/or made available, in particular by means of the evaluation device. The phrase “at least one” preferably also includes the meaning of “one” or “exactly one”.

Preferably, rotational signal components in the acceleration signals provided by the acceleration sensors of the body sensor arrangement can be, or are, at least partially, calculated and/or compensated for and/or calculated out and/or compensated, preferably by means of the evaluation device, with the aid of and/or taking into account the body rotational movement signals.

The number of vehicle wheels is preferably four. The vehicle wheels are preferably located in the corners of the vehicle. The chassis is advantageously provided with at least one vehicle axle, which in particular comprises two or at least two of the vehicle wheels. The chassis is preferably provided with several vehicle axles, which in particular each comprise two or at least two of the vehicle wheels. One of these axles is a front axle in particular. One or other of these vehicle axles is in particular a rear axle. The chassis is preferably provided with the or a front axle that in particular comprises two or at least two front wheels of the vehicle wheels. Preferably, the chassis is provided with the or a rear axle that in particular comprises two or at least two rear wheels of the vehicle wheels. The number of vehicle axles is advantageously two or at least two.

Preferably, each chassis sensor arrangement is provided on one of the vehicle wheels and/or on a wheel suspension of one of the vehicle wheels and/or on a wheel carrier supporting one of the vehicle wheels and/or on one of the chassis control arms and/or in one of the corners of the vehicle. The number of chassis sensor arrangements is, for example, one or at least one or two or at least two or three or at least three or four or at least four. One of the chassis sensor arrangements is provided in the area of each vehicle wheel of at least one vehicle axle or at least one of the vehicle axles. In particular, one of the chassis sensor arrangements is provided on each of the wheel carriers bearing the vehicle wheels on at least one vehicle axle or on at least one of the vehicle axles. For example, the number of chassis sensor arrangements corresponds to the number of front and/or rear wheels. In particular, each front wheel and/or each rear wheel is assigned to one of the chassis sensor arrangements. Preferably, one of the chassis sensor arrangements is provided in the area of each front wheel and/or each rear wheel. For example, one of the chassis sensor arrangements is provided on each of the front and/or rear wheel carriers. Preferably, the number of chassis sensor arrangements corresponds to the number of vehicle wheels. Preferably, one of the chassis sensor arrangements is assigned to each vehicle wheel. In particular, one of the chassis sensor arrangements is provided in the area of each vehicle wheel. For example, one of the chassis sensor arrangements is provided on each of the wheel carriers that support the vehicle wheels.

The preferred arrangement is a fixed orientation of the body sensor arrangement relative to the vehicle body. Preferably, each chassis sensor arrangement is arranged in a fixed orientation relative to the unsprung components of the chassis. Any chassis sensor arrangement that is arranged in a fixed orientation, in particular an essentially fixed orientation, relative to the ground is advantageous. The term “essentially” refers in particular to the suspension of the unsprung components of the chassis from the ground caused by pneumatic tires. The influence of this suspension is particularly neglected.

According to a favorable further training, the rotational movement sensors of the body sensor arrangement are designed as rotation rate sensors, by means of which, in particular, the rotational movements can be detected and/or are detected in the form of angular velocities. The body rotational movement signals are, in particular, angular velocity signals and can also be referred to as body angular velocity signals, for example. To determine and/or estimate the rotational signal components in the acceleration signals provided by the accelerometers of the body sensor arrangement, the body angular velocity signals can be integrated over time, for example.

The body sensor arrangement is preferably designed to detect three translational degrees of freedom. The body sensor arrangement is preferably designed to detect three degrees of rotational freedom. In particular, the body sensor arrangement is designed to detect six kinematic degrees of freedom.

Preferably, the body sensor arrangement can detect translational accelerations in three different spatial directions. Preferably, the body sensor arrangement can detect translational accelerations in three different body sensor arrangement directions. Preferably, each of the axes of rotation of the body sensor arrangement extends in one of the body sensor arrangement directions. It is advantageous if the axes of rotation of the body sensor arrangement intersect at a common origin.

The sensor arrangement in the body is preferably formed by an inertial measurement unit (IMU), in particular in the form of a microsystem (MEMS). The rotation rate sensors are also referred to as gyroscopes, for example. Microsystem-based inertial measurement units require little installation space, are low-maintenance, and relatively inexpensive to procure.

According to an advantageous design, each chassis sensor arrangement is designed to detect three or at least three kinematic degrees of freedom. In particular, each chassis sensor arrangement is designed to detect three translational degrees of freedom.

According to a beneficial training, each chassis sensor arrangement comprises a plurality of rotational movement sensors, by means of which rotational movements about different axes of rotation can be detected and/or are detected and these rotational movements characterizing chassis rotational movement signals are provided and/or will be provided. The pitch angle is or can be determined, in particular by means of the evaluation device, additionally taking into account the chassis rotational movement signals. The pitch angle of the vehicle can thus be determined and/or is determined from the acceleration signals, the body rotational movement signals, and the chassis rotational movement signals, preferably by means of the evaluation device. In particular, the orientation of the chassis and/or the ground can be determined more accurately, thus increasing the accuracy of the pitch angle measurement.

Preferably, by means of the evaluation device, rotational movement signal components in the acceleration signals provided by the acceleration sensors of the respective chassis sensor arrangement can be or are, in particular at least partially, calculated out and/or compensated out and/or compensated for with the aid of and/or taking into account the chassis rotational movement signals of each chassis sensor arrangement.

According to a favorable embodiment, the rotational movement sensors of each chassis sensor arrangement are designed as rotation rate sensors, by means of which the, in particular respective, rotational movements can be detected and/or are detected in the form of angular velocities. The chassis rotational movement signals are, in particular, angular velocity signals and can, for example, also be referred to as chassis angular velocity signals. To determine and/or estimate the rotational signal components in the acceleration signals provided by the acceleration sensors of each chassis sensor arrangement, the respective chassis angular velocity signals can be integrated over time, for example.

Each chassis sensor arrangement is designed, for example, to detect three rotational degrees of freedom. Preferably, each chassis sensor arrangement is designed to detect six kinematic degrees of freedom.

Preferably, each chassis sensor arrangement can detect translational acceleration in three different spatial directions. Advantageously, each chassis sensor arrangement can detect translational accelerations in three different chassis sensor arrangement directions. Preferably, for each chassis sensor arrangement, each of the axes of rotation lies in one of the chassis gear sensor arrangement directions of the respective chassis sensor arrangement. The axes of rotation of each chassis sensor arrangement intersect favorably, in particular each in a common origin.

Each chassis sensor arrangement is preferably formed by an inertial measurement unit (IMU), in particular in the form of a microsystem (MEMS). The rotation rate sensors are also referred to as gyroscopes, for example.

According to an advantageous further development, one or more body orientation information items about the orientation of the vehicle body can be and/or are determined, in particular by means of the evaluation device, on the basis of the signals provided by the body sensor arrangement. Preferred are or will be, in particular by means of the evaluation device, on the basis of the signals provided by the one or more chassis sensor arrangements, one or more chassis orientation information or ground orientation information about the orientation of the chassis and/or the ground can be determined and/or is determined. In particular, the pitch angle can be or is determined from the body orientation information and the chassis orientation information or the ground orientation information. The one or more pieces of chassis orientation information correspond, for example, to the one or more pieces of ground orientation information.

The one or more body orientation information items comprise, for example, only directional information, for example in a vehicle longitudinal-vertical plane. The one or more chassis orientation information or ground orientation information comprises, for example, only directional information, for example in the or a vehicle longitudinal elevation plane. If each piece of directional information is available, e.g., in the form of an angle, in particular with respect to the same reference axis, the pitch angle results, for example, from a difference of these angles.

The body orientation information preferably characterizes a body plane representing the vehicle body. The chassis orientation information or ground orientation information advantageously characterizes a chassis plane or ground plane representing the chassis or the ground. The chassis plane corresponds to the ground plane, for example, or is parallel to it. In particular, the pitch angle can be or is determined from the position of the body plane relative to the chassis plane or ground plane.

According to an advantageous embodiment, a roll angle of the vehicle can be determined and/or is determined, in particular by means of the evaluation device, from the signals provided by the sensor arrangements. For example, the roll angle can be or is determined from the position of the body plane relative to the chassis plane or ground plane. The roll angle is, in particular, a different angle of inclination of the vehicle. The pitch angle and roll angle, for example, are transverse to one another. A roll angle signal characterizing the roll angle is preferably provided and/or can be provided, in particular by means of the evaluation device.

Depending on the further training available, there is one wheel on each axle of the vehicle, or at least one of the vehicle axles, for example the front or rear axle, has one of the chassis sensor arrangements, Preferably, the chassis orientation information includes information about the orientation of the vehicle wheels of the vehicle axle, from which the wheel lifts of the vehicle wheels can be and/or are determined, in particular by means of the evaluation device. Preferably, the or a roll angle is or can be determined from the wheel lifts, in particular by means of the evaluation device. Since the positional relationship between the vehicle body and each vehicle wheel is predetermined by the chassis, a wheel lift of the respective vehicle wheel can also be determined from the detected orientation of each vehicle wheel and the body orientation information, wherein the roll angle can be determined from the wheel lifts of the vehicle wheels of the vehicle axle.

The body plane, for example, is described by a body plane vector that runs perpendicular to it. For example, the chassis plane or the ground plane is described by a perpendicular chassis plane vector or ground plane vector. The chassis plane vector corresponds, for example, to the ground plane vector. For example, an angle enclosed between the body plane vector and the chassis plane vector or ground plane vector results from a superimposition of pitch and roll.

According to a favorable training, the pitch angle is or can be corrected and/or determined, in particular by means of the evaluation device, preferably taking into account the roll angle. For example, a corrected body plane vector is given by a projection of the body plane vector onto a plane running perpendicular to the chassis plane or ground plane in the longitudinal direction of the vehicle, wherein the, in particular corrected, pitch angle is given by an angle enclosed between the corrected body plane vector and the chassis plane vector or ground plane vector. The projection is preferably carried out taking into account and/or using the roll angle. Instead of the aforementioned vectors, lines or line segments can also be used, since the determination of the pitch angle depends not on the magnitude of the vectors, but only on their direction.

According to a favorable embodiment, one or at least one headlight device, in particular connected to the evaluation device, is provided with at least one headlight and at least one headlight adjustment drive, by means of which the inclination of the headlight and/or of a light beam emitted by the latter can be adjusted and/or is adjusted as a function of the pitch angle, preferably relative to the vehicle body. Preferably, the headlight device includes at least one headlight holding device on which the at least one headlight is mounted, in particular such that it can be tilted and/or swiveled. In particular, the at least one headlight is a front headlight. The term “light beam” can be used instead of the term “light cone”, for example. The preferred arrangement is a fixed orientation of the body sensor arrangement relative to the headlight device and/or to the at least one headlight holding device. The at least one headlight holding device is preferably fixed to the vehicle body. Preferably, the headlight device includes two headlights and/or two headlight adjustment drives and/or two headlight holding devices. For example, the vehicle has one headlight device or at least one headlight device.

The evaluation device preferably includes a digital computer and/or is formed by one. Preferably, the evaluation device includes several analog-digital converters, by means of which the sensor signals supplied by the sensors can be digitized and/or are digitized.

The device according to the invention is in particular part of the vehicle. For example, the expression “device for detecting at least one angle of inclination of a vehicle” can also be replaced by the expression “vehicle” or by the expression “vehicle with a device for detecting at least one angle of inclination” or by the expression “vehicle with a device for detecting at least one angle of inclination of the vehicle”. The device according to the invention preferably includes the at least one body sensor arrangement and/or the one or more chassis sensor arrangements and/or the evaluation device and/or the headlight device and/or the chassis and/or the vehicle body and/or the vehicle springs and/or the chassis control arms and/or each wheel carrier.

### BRIEF DESCRIPTION OF THE DRAWINGS

The invention is described below with reference to a preferred embodiment with reference to the drawing. The drawing shows:

FIG. 1 a schematic top view of a vehicle,

FIG. 2 a schematic view of a wheel suspension of the vehicle,

FIG. 3 a schematic representation of a device for detecting at least one angle of inclination according to one embodiment,

FIG. 4 a schematic representation illustrating the determination of a pitch angle, and

FIG. 5 a schematic representation to illustrate the determination of a roll angle.

### DETAILED DESCRIPTION

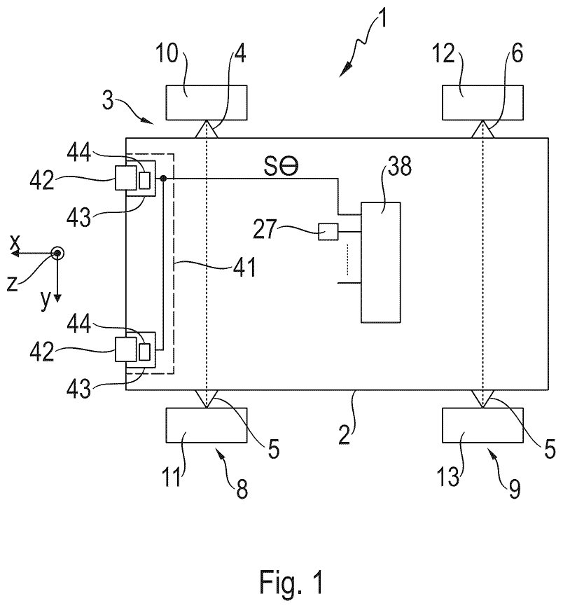

FIG. 1 schematically shows a top view of a vehicle 1, which has a vehicle body 2 and a chassis 3 with several wheel suspensions 4, 5, 6, and 7, of which wheel suspensions 4 and 5 are assigned to a front axle 8 and wheel suspensions 6 and 7 are assigned to a rear axle 9. Each wheel suspension comprises a vehicle wheel, wherein wheel suspension 4 has vehicle wheel 10, wheel suspension 5 has vehicle wheel 11, wheel suspension 6 has vehicle wheel 12, and wheel suspension 7 has vehicle wheel 13. Furthermore, a coordinate system with a longitudinal direction x, a transverse direction y, and a vertical direction z is shown.

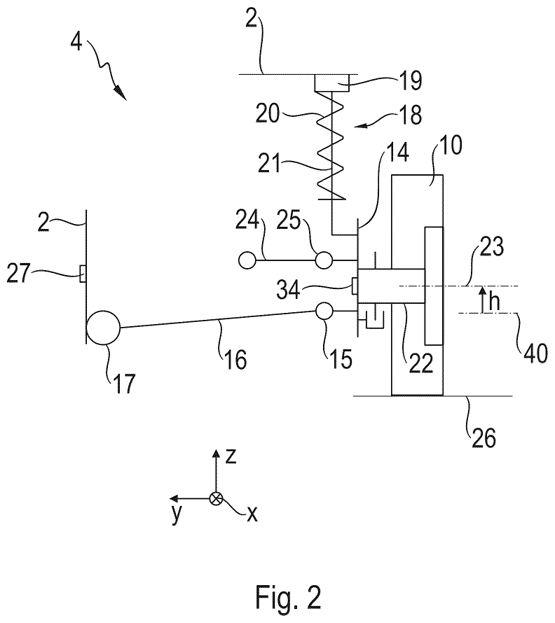

FIG. 2 shows a schematic view of the wheel suspension 4, which has a wheel carrier 14 which is connected by a joint 15, preferably in the form of a ball joint, to a chassis control arm 16, preferably in the form of a transverse control arm, whose end facing away from the wheel carrier 14 is articulated to the vehicle body 2 by at least one joint 17, preferably in the form of a rubber bearing. Furthermore, the wheel carrier 14 is connected, in particular fixedly, to a suspension strut 18, the end of which facing away from the wheel carrier 14 is connected to the vehicle body 2 by a suspension strut mount 19. The suspension strut 18 comprises a vehicle spring 20 and a damper 21, which is in particular surrounded by the vehicle spring 20, which is preferably designed as a helical spring. A wheel bearing 22 is attached to the wheel carrier 14, by means of which the vehicle wheel 10 is mounted on the wheel carrier 14 so as to be rotatable about a wheel axle 23. Furthermore, a tie rod 24 is connected to the wheel carrier 14 by means of a joint 25, preferably in the form of a ball joint. The vehicle wheel 10 is in contact with a ground 26, which is, for example, a road or a lane.

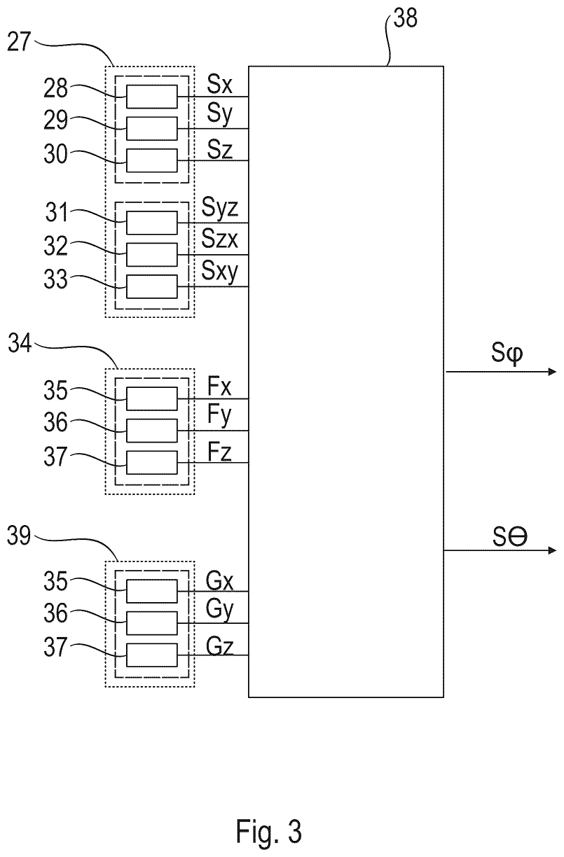

A body sensor arrangement 27 is provided on the vehicle body 2, which has three translational acceleration sensors 28, 29, and 30 as well as three rotation rate sensors 31, 32, and 33 (see FIG. 3). Furthermore, a chassis sensor arrangement 34 is provided on the wheel carrier 14, which has three translational acceleration sensors 35, 36, and 37 (see FIG. 3). Optionally, the chassis sensor arrangement 34 can additionally have three rotation rate sensors.

The wheel suspension 5 is preferably constructed in a mirror-inverted manner to the wheel suspension 4. Furthermore, the wheel suspension 7 is preferably constructed in a mirror-inverted manner to the wheel suspension 6. In particular, the front axle 8 is designed to be steerable. The rear axle, for example, is designed to be steerable or non-steerable. Apart from that, wheel suspensions 4, 5, 6, and 7 are particularly similar in design.

As can be seen from FIG. 3, the sensors of the sensor arrangements 27 and 34 are connected to an evaluation device 38. Furthermore, an optional chassis sensor arrangement 39 is provided, which is configured identically to the chassis sensor arrangement 34 and is arranged on a wheel carrier, which carries the vehicle wheel 11 of the wheel suspension 5, the translatory acceleration sensors 35, 36, and 37 of which are connected to the evaluation device 38. According to the aforementioned option, one of the chassis sensor arrangements is thus provided on each wheel carrier of the front axle 8.

The acceleration sensors 28, 29, and 30 of the body sensor arrangement 27 provide acceleration signals Sx, Sy, and Sz characterizing the accelerations occurring at the vehicle body 2. Furthermore, the rotation rate sensors 31, 32, and 33 of the body sensor arrangement 27 provide angular velocity signals Syz, Szx, and Sxy, which characterize rotational movements occurring on the vehicle body 2. The acceleration sensors 35, 36, and 37 of the chassis sensor arrangement 34 provide acceleration signals Fx, Fy, and Fz characterizing the accelerations occurring at the wheel carrier 14. Furthermore, the acceleration sensors 35, 36, and 37 of the optional chassis sensor arrangement 39, if present, provide acceleration signals Gx, Gy, and Gz that characterize the accelerations occurring at the wheel carrier of the vehicle wheel 11.

The orientation of the vehicle body 2 can be detected using the body sensor arrangement 27. Furthermore, the orientation of the wheel carrier 14 can be detected by means of the chassis sensor arrangement 34. Since the positional relationship between the vehicle body 2 and the wheel carrier 14 is predetermined by the wheel suspension 4, the detected orientations can be used, for example, to determine a wheel lift h of the vehicle wheel 10 relative to a reference position 40, which is, for example, fixed in relation to the vehicle body 2. The same applies to the optional chassis sensor arrangement 39, by means of which, if present, a wheel lift h of the vehicle wheel 11 can be detected, for example. Furthermore, the detected orientation of the wheel carrier 14 or the wheel carriers can also be used to detect the orientation of the ground 26, in particular if the influence of pneumatic tires is neglected. Preferably, the orientation of the ground 26 corresponds to the orientation of the wheel carrier 14 and/or the orientation of the ground 26 can be derived from the orientation of the wheel carrier 14.

A pitch angle θ of the vehicle 1 can be determined from the detected orientations, which is carried out in particular by means of the evaluation device 38, which also provides a pitch angle signal Sθ characterizing the pitch angle θ.

It is also possible to determine a roll angle φ of the vehicle 1 from the detected orientations and/or from the detected wheel lifts, which is carried out in particular by means of the evaluation device 38, which preferably provides a roll angle signal Sθ characterizing the roll angle φ.

Vehicle 1 has a headlight device 41 with two headlights 42, two headlight holding devices 43, on which the headlights 42 are pivotally mounted, and two headlight adjustment drives 44, by means of which the inclination of the headlights 42, in particular in the z-x plane, can be adjusted as a function of the pitch angle θ. For this purpose, the headlight device 41 connected to the evaluation device 38 is provided in particular with the pitch angle signal Sθ, which can be seen from FIG. 1.

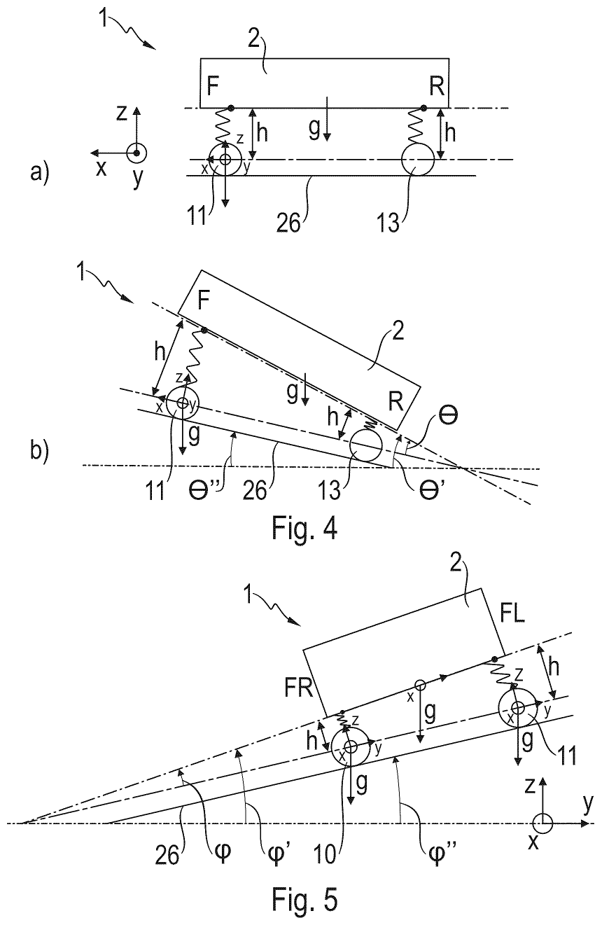

A determination of the pitch angle θ and the roll angle φ is illustrated below with reference to FIGS. 4 and 5.

FIG. 4 schematically shows the unladen, stationary vehicle 1 on a level supporting ground 26 in its design position on the left-hand side, marked a). The pitch angle and roll angle are therefore zero.

Furthermore, on the right-hand side marked (b) in FIG. 4, vehicle 1, which is preferably also loaded at the rear, is shown schematically on an inclined ground 26, causing vehicle 1 to pitch. The body sensor arrangement 27 is used to detect the orientation of the vehicle body 2 in the z-x plane, wherein this orientation is represented by an angle θ′. The angle θ′ can be roughly estimated from the acceleration signals of the body sensor arrangement 27 with: tan θ=Sx/Sz. However, due to the possibility of the sprung vehicle body 2 swaying, this estimate is relatively inaccurate, so that the angular velocity signals of the body sensor arrangement 27 are also taken into account to determine the angle θ′.

Furthermore, an orientation of the ground 26 in the z-x plane is detected by means of the chassis sensor arrangement 34, wherein this orientation is represented by an angle θ″ for which, in particular, the following applies: tan θ″=Fx/Fz.

The angle θ′ characterizes an orientation of the vehicle body 2 and thus provides information about the orientation of the body in particular. The angle θ″ characterizes an orientation of the chassis 3 or ground 26 and thus provides information about the orientation of the chassis or ground.

Thus, the pitch angle θ is obtained from the difference between the determined angles θ′ and θ′: θ=θ′−θ″.

In FIG. 4, the reference signs g stands for the acceleration due to gravity, F stands for “front”, and R stands for “rear”.

According to FIG. 5, the vehicle 1 is schematically represented on an inclined ground 26, so that a rolling motion of the vehicle 1 occurs. The body sensor arrangement 27 is used to detect the orientation of the vehicle body 2 in the y-z plane, wherein this orientation is represented by an angle φ′. The angle φ′ can be roughly estimated from the acceleration signals of the body sensor arrangement 27 with: tan φ′=Sy/Sz. However, due to a possible fluctuation of the spring-loaded vehicle body 2, this estimate is relatively inaccurate, so that the angular velocity signals of the body sensor arrangement 27 are also taken into account to determine the angle φ′.

Furthermore, the orientation of the ground 26 in the y-z plane is detected by means of the chassis sensor arrangement 34, wherein this orientation is represented by an angle φ″ for which the following applies in particular: tan σ″=Fy/Fz.

Thus, the roll angle φ results from the difference of the determined angles o′ and o″ to: φ=φ′−φ″.

In FIG. 5, the reference signs g stands for the acceleration due to gravity, FR for “front right”, and FL for “front left”.

As can be seen in FIGS. 4 and 5, the optional chassis sensor arrangement 39 is not absolutely necessary. However, their presence can increase the accuracy with which the pitch angle θ and/or roll angle φ can be determined.

### LIST OF REFERENCE NUMERALS

1 Vehicle
2 Vehicle body
3 Chassis
4 Wheel suspension
5 Wheel suspension
6 Wheel suspension
7 Wheel suspension
8 Front axle
9 Rear axle
10 Vehicle wheel
11 Vehicle wheel
12 Vehicle wheel
13 Vehicle wheel
14 Wheel carriers
15 Joint/ball joint
16 Chassis control arms/transverse control arms
17 Joint/rubber bearing
18 Suspension strut
19 Suspension strut mount
20 Vehicle spring
21 Damper
22 Wheel bearings
23 Wheel axle
24 Tie rod
25 Joint/ball joint
26 Ground
27 Body sensor arrangement
28 Acceleration sensor
29 Acceleration sensor
30 Acceleration sensor
31 Rotation rate sensor
32 Rotation rate sensor
33 Rotation rate sensor
34 Chassis sensor arrangement
35 acceleration sensor
36 acceleration sensor
37 Acceleration sensor
38 Evaluation device
39 Chassis sensor arrangement (optional)
40 Reference position
41 Headlight device
42 Headlight
43 Headlight holding device
44 Headlight adjustment drive
φ Roll angle
θ Pitch angle
Sx Acceleration signal
Sy Acceleration signal
Sz Acceleration signal
Syz Angular velocity signal
Szx Angular velocity signal
Sxy Angular velocity signal
Fx Acceleration signal
Fy Acceleration signal
Fz Acceleration signal
Gx Acceleration signal
Gy Acceleration signal
Gz Acceleration signal

1. A device for detecting at least one angle of inclination of a vehicle, having a chassis (3) with a plurality of vehicle wheels (10, 11, 12, 13) standing on or rolling on a ground (26), a vehicle body (2) carried by the chassis (3) and connected by vehicle springs (20) to unsprung components of the chassis (3) which comprise the vehicle wheels (10, 11, 12, 13) and which are coupled to the vehicle body (2) by means of chassis control arms (16), the device comprising:
a plurality of sensor arrangements (27, 34), of which at least one body sensor arrangement (27) is provided on the vehicle body (2) and one or more chassis sensor arrangements (34) is/are provided on the unsprung components of the chassis (3) and/or the chassis control arms, wherein each sensor arrangement comprises a plurality of acceleration sensors (28, 29, 30; 35, 36, 37), by means of which translatory accelerations in different spatial directions (x, y, z) can be detected and acceleration signals (Sx, Sy, Sz; Fx, Fy, Fz) can be provided; and
an evaluation device (38) connected to the sensor arrangements (27, 34), by means of which a pitch angle (0) of the vehicle (1) can be determined from the acceleration signals;
wherein the body sensor arrangement (27) comprises a plurality of rotational movement sensors (31, 32, 33) by means of which rotational movements about different axes of rotation can be detected and body rotational movement signals (Syz, Szx, Sxy) characterizing these rotational movements can be provided, and
wherein the pitch angle (0) can also be determined by means of the evaluation device (33) taking into account the body rotational movement signals (Syz, Szx, Sxy).

2. The device according to claim 1, wherein the rotational movement sensors (31, 32, 33) of the body sensor arrangement are configured as rotation rate sensors, by means of which the rotational movements can be detected in the form of angular velocities.

3. The device according to claim 2, wherein the body sensor arrangement (27) is configured to detect six kinematic degrees of freedom.

4. The device according to each of the one or more chassis sensor arrangements (34) is configured to detect at least three kinematic degrees of freedom.

5. A device according to claim 1, wherein body orientation information (θ′) about the orientation of the vehicle body (2) can be determined by means of the evaluation device (38) on the basis of the signals provided by the body sensor arrangement (27), wherein ground orientation information (θ″) about the orientation of the ground (26) can be determined on the basis of the signals provided by the one or more chassis sensor arrangements (34), and wherein the pitch angle (θ) can be determined from this orientation information (θ′, θ″).

6. The device according to claim 1, wherein a roll angle (φ) of the vehicle can be determined by means of the evaluation device from the signals provided by the sensor arrangements (27, 34).

7. The device according to one of the preceding claims, characterized in that claim 1, wherein the pitch angle (θ) is correctable taking into account the roll angle (φ).

8. The device according to claim 1, comprising at least one headlight device (41) connected to the evaluation device (38) and having at least one headlight (42) and at least one headlight adjustment drive (44), by means of which the inclination of the headlight (42) and/or of a light beam emitted by the latter can be adjusted as a function of the pitch angle (θ).

9. A method for detecting at least one angle of inclination of a vehicle, having a chassis (3) with a plurality of vehicle wheels (10, 11, 12, 13) that stand on or roll on a ground (26), a vehicle body (2) that is carried by the chassis (3) and is connected by vehicle springs (20) to unsprung components of the chassis (3) comprising the vehicle wheels (10, 11, 12, 13) which are coupled to the vehicle body (2) by means of chassis control arms (16), and a plurality of sensor arrangements (27, 34), of which at least one body sensor arrangement (27) is provided on the vehicle body (2) and one or more chassis sensor arrangements (34) are provided on the unsprung components of the chassis (3) and/or the chassis control arms, wherein each sensor arrangement (27, 34) comprises a plurality of acceleration sensors (28, 29, 30; 35, 36, 37), and the body sensor arrangement comprises a plurality of rotational movement sensors, the method comprising:
detecting translatory accelerations in different spatial directions (x, y, z);
providing acceleration signals (Sx, Sz, Sy; Fx, Dy, Fz) characterizing the accelerations
determining a pitch angle (θ) of the vehicle from the acceleration signals;
detecting, using the body sensor arrangement, rotational movements about different axes of rotation;
providing body rotational movement signals (Syz, Szx, Sxy) characterizing the rotational movements; and
determining a pitch angle (θ) taking into account the body rotational movement signals (Syz, Szx, Sxy).

10. The method according to claim 9, comprising determining a roll angle (φ) of the vehicle from the signals provided by the sensor arrangements (27, 34).

11. The method according to claim 10, comprising correcting the pitch angle (θ) taking into account the roll angle (φ).

12. The method according to claim 9, wherein the vehicle has at least one headlight device (41) with at least one headlight (42) and at least one headlight adjustment drive (44), and the method comprising adjusting the inclination of the headlight (42), and/or of a light beam emitted by the headlight, as a function of the pitch angle (θ).
